(19) United States
(12) Patent Application Publication
(10) Pub. No.: US 2013/0079018 A1
(43) Pub. Date: Mar. 28, 2013

(54) Handover Preparation

(71) Applicants: Oumer Teyeb, Stockholm (SE); Simone Redana, Munich (DE); Bernhard Raaf, Neuried (DE)

(72) Inventors: Oumer Teyeb, Stockholm (SE); Simone Redana, Munich (DE); Bernhard Raaf, Neuried (DE)

(21) Appl. No.: 13/695,381

(22) PCT Filed: Dec. 31, 2010
(86) PCT No.: PCT/EP10/70956

§ 371 Date: Dec. 3, 2012

(30) Foreign Application Priority Data
Apr. 30, 2010 (GB) 1007260.1

(51) Int. Cl. H04W 36/32

(52) U.S. Cl. CPC H04W 36/32
USPC 455/441; 455/436

(57) ABSTRACT

There are provided measures for proximity reporting procedures in radio access, for example in heterogeneous network environments, said measures exemplarily including sending, to a serving base station representing a source of mobility of a user equipment, a first proximity indication indicating proximity to a microcell base station representing a target of mobility of said user equipment, said first proximity indication including a carrier according to a preceding access of said user equipment to the microcell base station, and, when detecting the microcell base station on said carrier according to the preceding access fails, sending, to the serving base station, a second proximity indication indicating proximity to the microcell base station, said second proximity indication including a carrier being different from said carrier according to the preceding access. Said measures may exemplarily be applied for mobility procedures in LTE, LTE-Advanced, HSPA and/or UMTS radio access systems.

The present invention relates to preparations for the handover of a communication device from an existing access node to a new access node.

A communication device can be understood as a device provided with appropriate communication and control capabilities for enabling use thereof for communication with others parties. The communication may comprise, for example, communication of voice, electronic mail (email), text messages, data, multimedia and so on. A communication device typically enables a user of the device to receive and transmit communication via a communication system and can thus be used for accessing various service applications.

A communication system is a facility which facilitates the communication between two or more entities such as the communication devices, network entities and other nodes. A communication system may be provided by one or more interconnected networks. One or more gateway nodes may be provided for interconnecting various networks of the system. For example, a gateway node is typically provided between an access network and other communication networks, for example a core network and/or a data network.

An appropriate access system allows the communication device to access the wider communication system. An access to the wider communications system may be provided by means of a fixed line or wireless communication interface, or a combination of these. Communication systems providing wireless access typically enable at least some mobility for the users thereof. Examples of these include wireless communications systems where the access is provided by means of an arrangement of cellular access networks. Other examples of wireless access technologies include different wireless local area networks (WLANs) and satellite based communication systems. A wireless access system typically operates in accordance with a wireless standard and/or with a set of specifications which set out what the various elements of the system are permitted to do and how that should be achieved. For example, the standard or specification may define if the user, or more precisely user equipment, is provided with a circuit switched bearer or a packet switched bearer, or both. Communication protocols and/or parameters which should be used for the connection are also typically defined. For example, the manner in which communication should be implemented between the user equipment and the elements of the networks and their functions and responsibilities are typically defined by a predefined communication protocol. Such protocols and or parameters further define the frequency spectrum to be used by which part of the communications system, the transmission power to be used etc.

In the cellular systems a network entity in the form of a base station provides a node for communication with mobile devices in one or more cells or sectors. It is noted that in certain systems a base station is called ‘Node B’. Typically the operation of a base station apparatus and other apparatus of an access system required for the communication is controlled by a particular control entity. The control entity is typically interconnected with other control entities of the particular communication network. Examples of cellular access systems include GSM (Global System for Mobile) EDGE (Enhanced Data for GSM Evolution) Radio Access Networks (GERAN), Universal Terrestrial Radio Access Networks (UTRAN), Evolved Universal Terrestrial Radio Access Networks (EUTRAN). Recent developments of EUTRAN are Long Term Evolution (LTE) and LTE-Advanced (LTE-A).

Where an access node is serving a mobile communication device, it often becomes necessary to handover the communication device to another access node as the communication devices moves out of the area served by the current access node. There has been identified the challenge of providing a technique by which an optimum access node can be efficiently selected for handover of the communication device.

It is an aim to meet this challenge.

There is provided a method, comprising: receiving at a first node one or more handover request messages relating to a handover of a communication device in a source cell not served by said first node, wherein said one or more handover request messages identify a plurality of target cell candidates for said handover including at least one cell served by said first node and one or more cells other than cells served directly by said first node; selecting at said first node one or more of said plurality of target cell candidates; and sending a message identifying the one or more selected target cell candidates towards an access node serving the source cell.

In one embodiment, the selecting takes into account information about speed of movement of the communication device.

In one embodiment, the method further comprises: receiving at said first node said information about speed of movement of the communication device as part of the one or more handover request messages.

In one embodiment, the method further comprises: selecting one or more of said one or more cells other than cells directly served by said first node as one or more preferred target cell candidates; and selectively sending a handover request message addressed to one or more nodes directly serving said one or more preferred target cell candidates.

In one embodiment, the method further comprises: sending handover request messages respectively addressed to one or more nodes directly serving one or more of said one or more cells other than cells served directly by said first node; receiving from said one or more nodes respective acknowledgment messages including information regarding the suitability of the respective target cell candidates as the target cell for the handover; and selecting at said first node one or more of said plurality of target cell candidates based at least partly on said information included in the messages received from said one or more nodes.

In one embodiment, the method further comprises: generating handover cancellation messages respectively addressed to each of the one or more nodes from which said acknowledgement messages were received, except for the one or more nodes directly serving the selected target cell candidates.

In one embodiment, said one or more cells other than cells directly served by said first node include one or more cells served by the first node via one or more relay nodes.

In one embodiment, the one or more handover request messages include information about the radio conditions between the communication device and the plurality of target cell candidates.

In one embodiment, said first node is a node serving one of the plurality of target cell candidates selected by the access node serving the source cell as its preferred target cell candidate.

In one embodiment, the one or more target cell candidates selected at said first node consists of a single target cell candidate or a group of target cell candidates defining a subset of all the target cell candidates identified in the one or more handover request messages received at the first node.

In one embodiment, the one or more target cell candidates selected at said first node consists of a single target cell candidate.

There is also provided a method, comprising: sending from an access node serving a source cell one or more handover request messages relating to a handover of a communication device in said source cell, wherein said one or more handover request messages identify a plurality of target cell candidates for said handover; receiving at said access node serving said source cell an indication of the result of a selection at another node serving one or more of said target cell candidates of one or more of said plurality of target cell candidates.

In one embodiment, said selected one or more of said plurality of target cell candidates consists of a single target cell candidate or a group of target cell candidates defining a subset of all the target cell candidates identified in the one or more handover request messages sent from the access node serving the source cell.

In one embodiment, said selected one or more of said plurality of target cell candidates consists of a single target cell candidate.

In one embodiment, the method further comprises: receiving at said access node serving said source cell an indication of the result of a selection at another node serving one or more of said target cell candidates of a group of target cell candidates defining a subset of all the target cell candidates identified in the one or more handover request messages sent from the access node serving the source cell; and selecting at said access node serving the source cell one of said group of target cell candidates as the target cell for the handover.

In one embodiment, the method further comprises: receiving said indication of the result of said selection of said group of target cell candidates in a single handover request acknowledgement message.

In one embodiment, the method further comprises: sending from said access node serving said source cell a single handover request message identifying the plurality of target cell candidates for the handover.

There is also provided an apparatus comprising: a processor and memory including computer program code, wherein the memory and computer program code are configured to, with the processor, cause the apparatus to: receive at a first node one or more handover request messages relating to a handover of a communication device in a source cell not served by said first node, wherein said one or more handover request messages identify a plurality of target cell candidates for said handover including at least one cell served by said first node and one or more cells other than cells served directly by said first node; select at said first node one or more of said plurality of target cell candidates; and send a message identifying the one or more selected target cell candidates towards an access node serving the source cell.

In one embodiment, the memory and computer program code are configured to, with the processor, cause the apparatus to: select one or more of said plurality of target cell candidates taking into account information about speed of movement of the communication device.

In one embodiment, the memory and computer program code are configured to, with the processor, cause the apparatus to: receive at said first node said information about speed of movement of the communication device as part of the one or more handover request messages.

In one embodiment, the memory and computer program code are configured to, with the processor, cause the apparatus to: select one or more of said one or more cells other than cells directly served by said first node as one or more preferred target cell candidates; and selectively send a handover request message addressed to one or more nodes directly serving said one or more preferred target cell candidates.

In one embodiment, the memory and computer program code are configured to, with the processor, cause the apparatus to: send handover request messages respectively addressed to one or more nodes directly serving one or more of said one or more cells other than cells served directly by said first node; receive from said one or more nodes respective acknowledgment messages including information regarding the suitability of the respective target cell candidates as the target cell for the handover; and select at said first node one or more of said plurality of target cell candidates based at least partly on said information included in the messages received from said one or more nodes.

In one embodiment, the memory and computer program code are configured to, with the processor, cause the apparatus to: generate handover cancellation messages respectively addressed to each of the one or more nodes from which said acknowledgement messages were received, except for the one or more nodes directly serving the selected target cell candidates.

In one embodiment, said one or more cells other than cells directly served by said first node include one or more cells served by the first node via one or more relay nodes.

In one embodiment, the one or more handover request messages include information about the radio conditions between the communication device and the plurality of target cell candidates.

In one embodiment, said first node is a node serving one of the plurality of target cell candidates selected by the access node serving the source cell as its preferred target cell candidate.

In one embodiment, the one or more target cell candidates selected at said first node consists of a single target cell candidate or a group of target cell candidates defining a subset of all the target cell candidates identified in the one or more handover request messages received at the first node.

In one embodiment, the one or more target cell candidates selected at said first node consists of a single target cell candidate.

There is also provided an apparatus comprising: a processor and memory including computer program code, wherein the memory and computer program code are configured to, with the processor, cause the apparatus to: send from an access node serving a source cell one or more handover request messages relating to a handover of a communication device in said source cell, wherein said one or more handover request messages identify a plurality of target cell candidates for said handover; and receive at said access node serving said source cell an indication of the result of a selection at another node serving one or more of said target cell candidates of one or more of said plurality of target cell candidates.

In one embodiment, said selected one or more of said plurality of target cell candidates consists of a single target cell candidate or a group of target cell candidates defining a subset of all the target cell candidates identified in the one or more handover request messages sent from the access node serving the source cell.

In one embodiment, said selected one or more of said plurality of target cell candidates consists of a single target cell candidate.

In one embodiment, the memory and computer program code are configured to, with the processor, cause the apparatus to: receive at said access node serving said source cell an indication of the result of a selection at another node serving one or more of said target cell candidates of a group of target cell candidates defining a subset of all the target cell candidates identified in the one or more handover request messages sent from the access node serving the source cell; and select at said access node serving the source cell one of said group of target cell candidates as the target cell for the handover.

In one embodiment, the memory and computer program code are configured to, with the processor, cause the apparatus to: receive said indication of the result of said selection of said group of target cell candidates in a single handover request acknowledgement message.

In one embodiment, the memory and computer program code are configured to, with the processor, cause the apparatus to: send from said access node serving said source cell a single handover request message identifying the plurality of target cell candidates for the handover.

There is also provided an apparatus configured to perform any of the above-described methods.

In one embodiment, the above-described apparatus comprises one of: a base station, an eNodeB and a relay node.

There is also provided a computer program product comprising program code means which when loaded into a computer controls the computer to: receive at a first node one or more handover request messages relating to a handover of a communication device in a source cell not served by said first node, wherein said one or more handover request messages identify a plurality of target cell candidates for said handover including at least one cell served by said first node and one or more cells other than cells served directly by said first node; select at said first node one or more of said plurality of target cell candidates; and send a message identifying the one or more selected target cell candidates towards an access node serving the source cell.

There is also provided a computer program product comprising program code means which when loaded into a computer controls the computer to: send from an access node serving a source cell one or more handover request messages relating to a handover of a communication device in said source cell, wherein said one or more handover request messages identify a plurality of target cell candidates for said handover; receive at said access node serving said source cell an indication of the result of a selection at another node serving one or more of said target cell candidates of one or more of said plurality of target cell candidates.

Hereunder embodiments of the present invention will be described in detail, by way of example only, with reference to the following drawings, in which:

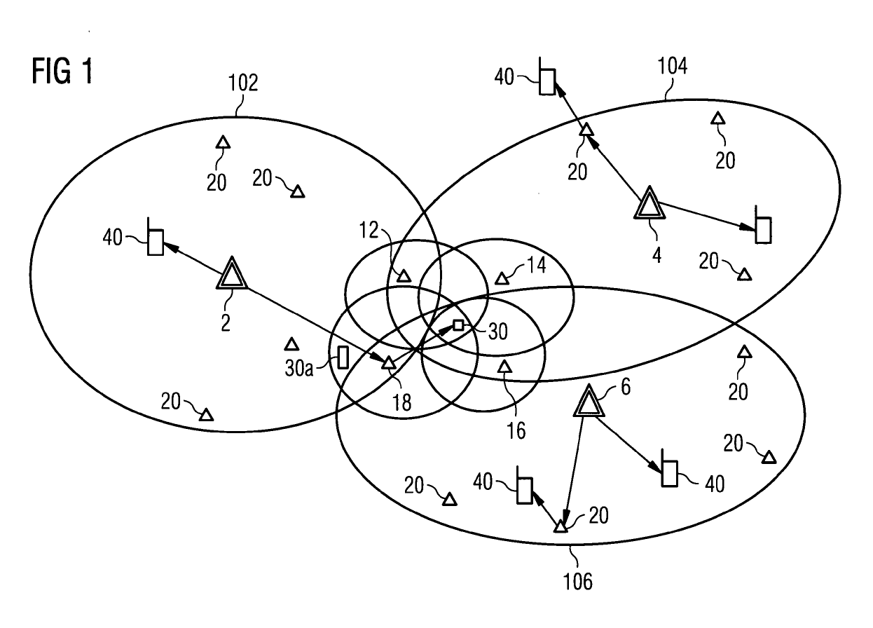

FIG. 1 illustrates an example of a system in which embodiments of the present invention can be implemented;

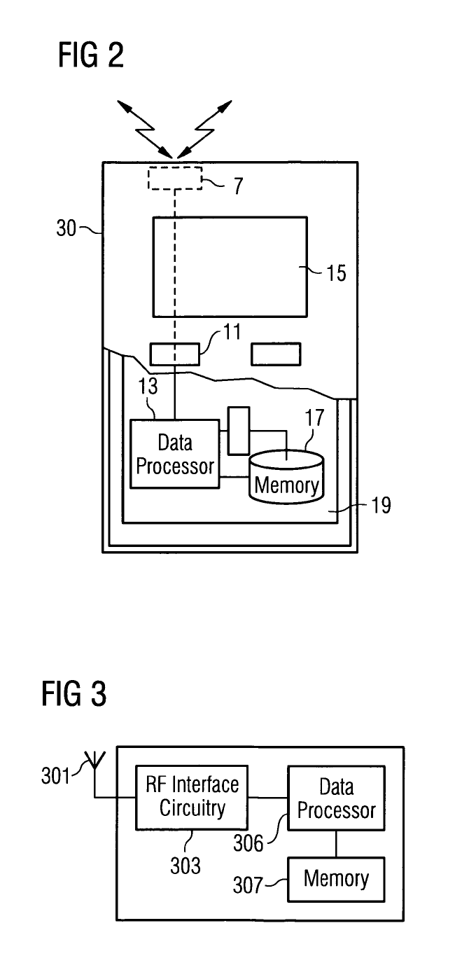

FIG. 2 illustrates a user equipment shown in FIG. 1 in further detail;

FIG. 3 illustrates an apparatus suitable for implementing an embodiment of the invention at a relay node or base station of the system shown in FIG. 1;

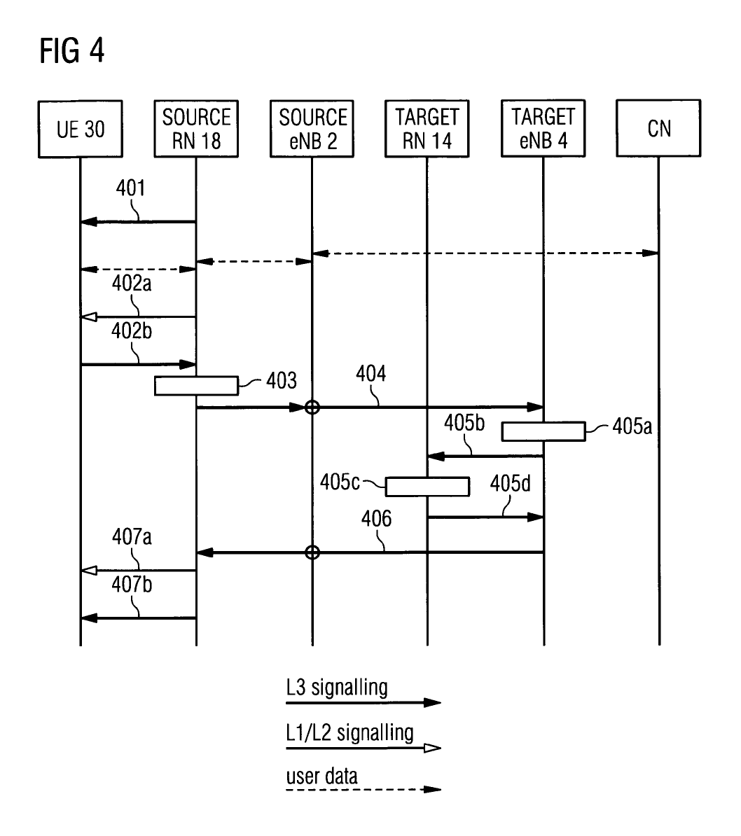

FIG. 4 illustrates a technique according to an embodiment of the present invention.

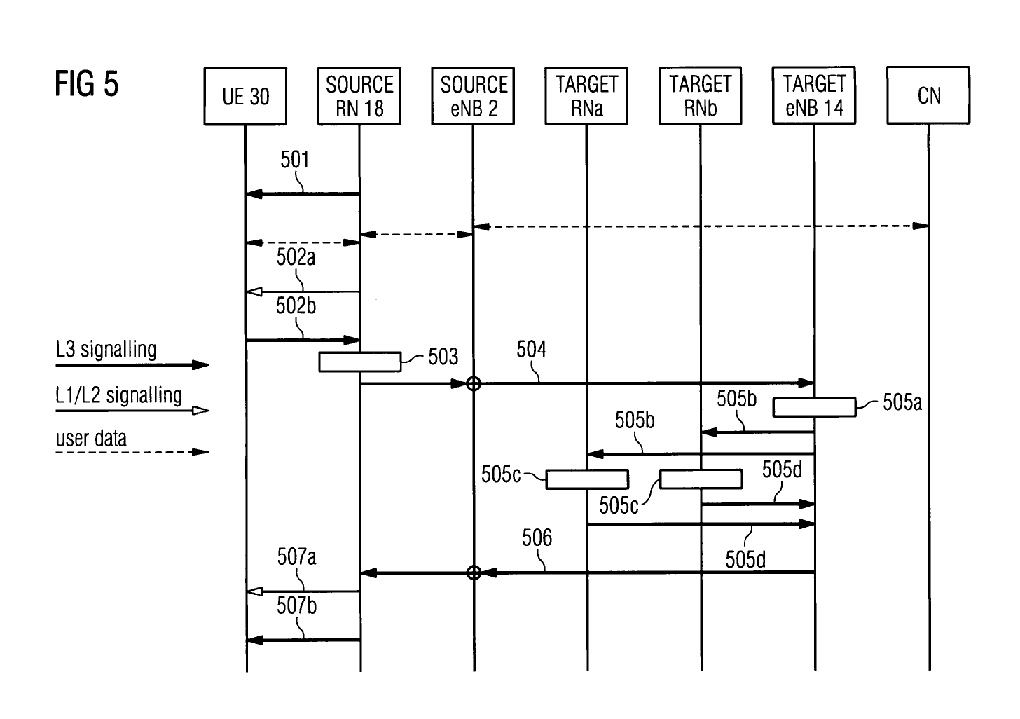

FIG. 5 illustrates a technique according to another embodiment of the present invention.

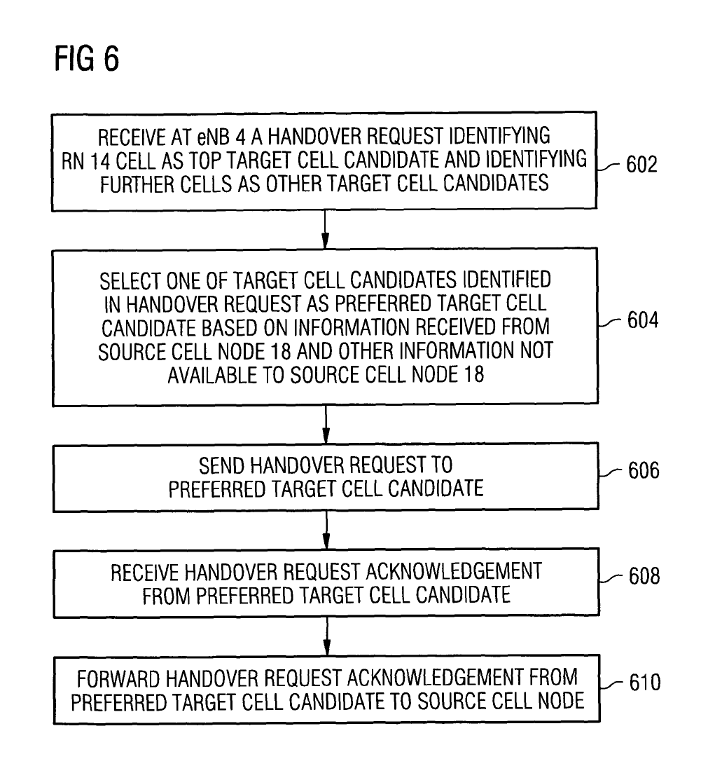

FIG. 6 illustrates a set of operations carried out at a base station of FIG. 1 in accordance with an embodiment of the present invention; and

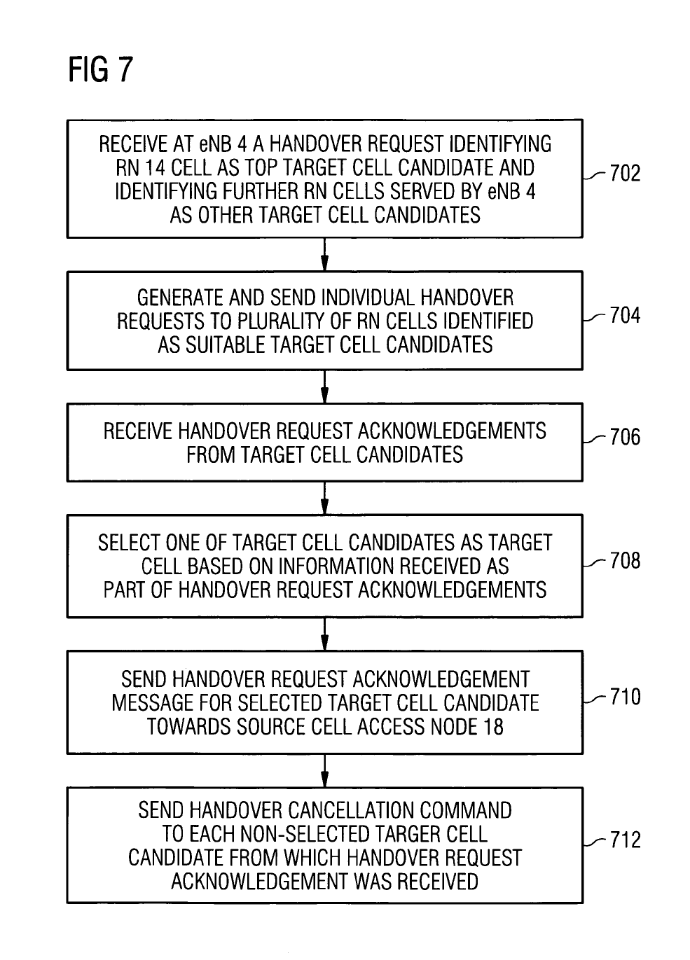

FIG. 7 illustrates a set of operations carried out at a base station of FIG. 1 in accordance with an embodiment of the present invention.

A LTE-A network involving relay nodes (RNs) has been chosen to describe some embodiments of the invention; but the same kind of techniques also have use in other types of networks with or without relay nodes.

FIG. 1 illustrates three cells of an E-UTRAN network deployed with relay nodes. The base stations (DeNB) 2, 4 and 6 with respective coverage areas (cells) 102, 104 and 106 communicate directly with one or more user equipments 30, 40, and also indirectly with other user equipments 40 via respective relay nodes 12, 14, 16, 18 and 20 with which the base stations 2, 4 and 6 communicate via a wireless interface. Each of the relay nodes 12, 14, 16 and 18 has a respective coverage area (cell) which may lie wholly within the coverage area (cell) of the respective donor base station (DeNB) or may extend partly out of the coverage area (cell) of the respective donor base station DeNB. The relay nodes can be useful in overcoming excessive shadowing, or facilitating an increase in throughput in areas of high traffic (hotspots). The latter kind of relay node can be additionally useful for extending the effective coverage of a base station (DeNB) e.g. the coverage where certain data rates can be achieved. One example of a relay node is a Layer 3 (L3) RN, also known as Type 1 RN or self-backhauling RN, where the RN appears as a normal base station towards UEs. In other words, the RN operates so as to be recognized as a normal eNB cell by the UEs. According to one example of an architecture for realizing Type 1 relays, the DeNB acts like a proxy for both S1 and X2 signalling, effectively hiding the RN from the core network (CN). From the CN point of view, the relayed UEs are connected directly to the DeNB, and the RN cell appears to the CN as an ordinary cell within the DeNB.

For the description of embodiments of the present invention, we have chosen the situation of a user equipment (UE) 30 which is currently served by DeNB 2 via relay node (RN) 18, and has moved from a position 30a to a current position 30 in which it is near the edge of the area served by relay node 18 and is now within the areas served by relay nodes 14 and 16 and also the areas served directly by DeNB 4 and DeNB 6. Relay node 18 is associated with DeNB 2; relay node 14 is associated with DeNB 4; and relay node 16 is associated with DeNB 6. The base stations (DeNB) will typically have a large number of relay nodes associated with each thereof.

FIG. 2 shows a schematic partially sectioned view of an example of user equipment that may be used for at least receiving data directly or indirectly from an eNB via one or more wireless interfaces. The user equipment may be used for various tasks such as making and receiving phone calls, for receiving and sending data from and to a data network and for experiencing, for example, multimedia or other content.

The user equipment may be any device capable of at least sending or receiving radio signals. Non-limiting examples include a mobile station (MS), a portable computer provided with a wireless interface card or other wireless interface facility, personal data assistant (PDA) provided with wireless communication capabilities, or any combinations of these or the like. The user equipment may communicate via an appropriate radio interface arrangement of the user equipment. The interface arrangement may be provided for example by means of a radio part 7 including associated antenna arrangement. The antenna arrangement may be arranged internally or externally to the user equipment.

The user equipment may be provided with at least one data processing entity 13 and at least one memory or data storage entity 17 for use in tasks it is designed to perform. The data processor 13 and memory 17 may be provided on an appropriate circuit board 19 and/or in chipsets.

The user may control the operation of the user equipment by means of a suitable user interface such as key pad 11, voice commands, touch sensitive screen or pad, combinations thereof or the like. A display 15, a speaker and a microphone may also be provided. Furthermore, the user equipment may comprise appropriate connectors (either wired or wireless) to other devices and/or for connecting external accessories, for example hands-free equipment, thereto.

FIG. 3 shows an example of an apparatus for use at a relay node or at a base station (eNB). The apparatus comprises a plurality of radio frequency antennae 301 configured to receive and transmit radio frequency signals, radio frequency interface circuitry 303 configured to interface the radio frequency signals received and transmitted by the antennae 301 and the data processor 307. The radio frequency interface circuitry may also be known as a transceiver. The data processor 307 is configured to process signals from the radio frequency interface circuitry 303, control the radio frequency interface circuitry 303 to generate suitable RF signals to communicate information to a relay node or a user equipment via a wireless communications link. The apparatus further comprises a memory 307 for storing data, parameters and instructions for use by the data processor 305.

It will be appreciated that both the user equipment and relay node/eNB apparatus shown in FIGS. 2 and 3 respectively and described above may comprise further elements which are not directly involved with the embodiments of the invention described hereafter.

Operations common to first and second embodiments of the present invention are as follows:

UE 30 receives a measurement control command from relay node 18 via Layer 3 (L3) signalling (STEPS 401 and 501). In its current location, UE 30 detects reference signals from relay nodes 14 and 16 and base stations 4 and 6 in addition to the reference signal from the relay node 18 that is currently serving UE 30. UE 30 sends reports of the measurements of these reference signals to the source relay node 18 via L3 signalling (STEP 402b and 502b) on uplink (UL) resources specified in an UL allocation grant detected by UE 30 (STEPS 402a and 502a). Based on the received measurement reports, relay node 18 identifies e.g. relay node 14 as its top target cell candidate (STEPS 403 and 503), i.e. relay node 18 determines that the UE 30 should ideally be handed over to relay node 14, while a handover to relay node 16 or base stations 4 and 6 would also be feasible, but less desirable e.g. due to worse signal strengths from them.

Relay node 18 generates a handover request specifying RN cell 14 as the top target cell candidate and specifying other cells as additional target cell candidates; and sends the handover request towards the RN cell via the eNB associated with RN cell 14, i.e. eNB 4 (STEPS 404 and 504). Alternatively, relay node 18 generates a group of handover requests; one for each cell identified as a target cell candidate, and sends the group of handover requests towards the respective targets. The handover request (or group of handover requests) comprises an information element including (a) information about each target cell candidate (or the respective target cell candidate, in the case of a group of handover requests), such as UE measurement reports, as well as (b) general information about UE 30, such as an indication of the speed of movement of UE 30.

According to a first embodiment of the present invention illustrated in FIG. 4, the operation then proceeds as follows. Upon receiving the handover request message (STEP 602 of FIG. 6), Target eNB 4 selects one of the target cell candidates identified in the Handover Request message received from source cell node 18 (STEP 405a of FIG. 4 and STEP 604 of FIG. 6). Target eNB 4 selectively sends a Handover Request message to the access node serving the selected cell (STEP 405b of FIG. 4 and STEP 606 of FIG. 6), and does not send any Handover Request message to any of the access nodes serving the other target cell candidates identified in the Handover request message received from source cell node 18. Target eNB 4 makes the above-mentioned selection based on information received from the source cell node (such as the reference signal measurement reports, and information about the speed of movement of UE 30 etc.), and also based on information not available to source cell node 18, such as information about the load conditions of the cells identified as target cell candidates in the handover request message received from the source cell node 18. Accordingly, the target cell candidate selected by eNB 4 may not be the same as the target cell identified by the source cell access node as its top target cell candidate.

Upon receiving the handover request, the access node (Target RN) for the target cell candidate selected by eNB 4 carries out a UE admission control operation (STEP 405c), by which it checks what resources it has for an access link between it and the UE 30. Target RN sends a handover request acknowledgement message to eNB 4 (STEP 405d). Upon receiving the handover acknowledgement message (STEP 608 of FIG. 6), Target eNB 4 forwards the handover request acknowledgement message towards source cell access node 18 (STEP 406 of FIG. 4 and STEP 610 of FIG. 6). Source cell access node 18 generates a RRC Connection Reconfiguration message (including mobility control information) and transmits it (STEP 407b) via resources identified to UE 30 by a downlink (DL) allocation grant using L1/L2 signalling (STEP 407a).

In the event that (i) the cell served directly by eNB 4 was one of the target cell candidates identified in the handover request message received at eNB 4 from source cell access node 18, and (ii) a cell served directly by eNB 4 was selected by Target eNB 4 as the target cell: steps 405b to 405d are omitted, and a handover request acknowledgement message identifying the cell served directly by eNB 4 as the target cell for the handover is sent from eNB 4 towards source cell access node 18.

In the event that eNB 4 does not have enough information to select one cell from among RN 14 and one or more cells directly served by eNB4, eNB 4 can send towards source cell access node 18 one or more handover request acknowledgement messages (either a single message or multiple messages) for more than one selected cell (which plurality of selected cells can be differentiated in the one or more handover request acknowledgement messages by the included cell IDs of those selected cells) and then the source access node 18 selects one of those selected cells as the target cell. The plurality of selected cells can be a subset of the target cell candidates received during STEP 404.

According to a second embodiment of the present invention illustrated in FIGS. 5 and 7, the operations proceed from STEP 504 as follows. Upon receiving the handover request identifying two or more of its RN cells as target cell candidates (STEP 702 of FIG. 7), the eNB 4 performs one or more checks as to the suitability of each relay node identified in the handover request message received from the source cell access node 18 based on information already available to eNB 4. For example, eNB 4 performs an admission control operation (STEP 505a) by which it checks whether there are resources available for the backhaul link between eNB 4 and the respective relay node. For each relay node that is both: (a) identified in the handover request message received from the source cell access node 18, and (b) for which eNB 4 has confirmed that there are backhaul link resources available: eNB 4 generates a respective individual handover request message, and sends the individual handover request messages towards those relay nodes (STEP 505b of FIG. 5 and STEP 704 of FIG. 7). For simplicity of explanation, FIG. 5 illustrates an example where eNB 4 sends handover request messages to only two relay nodes RNa and RNb. Upon receiving their respective handover request message, RNa and RNb each perform a UE Admission Control operation (STEP 505c) by which they check whether there are resources available for the access link between the respective relay node and UE 30. The required resource estimation by RNa and RNb might consider the measurement report included in the handover request message, as the required resources to serve UE 30 are highly dependent on the quality of the radio link between the RNs and the UE. If the necessary resources are available, the respective relay node generates a handover request acknowledgement message and forwards it towards eNB 4 (STEP 505d).

Based on the information contained in the handover request acknowledgement messages received from RNa and RNb (STEP 706), and the information that eNB 4 already has about the target cell suitability of one or more cells served directly by eNB 4, eNB 4 selects a cell as the target cell for the handover of UE 30 (STEP 708). The suitability check of the best target cell candidate may be based on information such as the number of radio bearers of UE 30 that were admitted, the total throughput that UE 30 can get, etc., which is information that can be found (either directly or indirectly) from the received handover acknowledgement messages from the target RNs. eNB 4 forwards towards source cell access node 18 the handover request acknowledgement message for the selected cell (STEP 506 of FIG. 5 and STEP 710 of FIG. 7).

Source cell access node 18 generates a RRC Connection Reconfiguration message (including mobility control information) and transmits it (STEP 507b) via resources identified to UE 30 by a downlink (DL) allocation grant using L1/L2 signalling (STEP 507a).

This second embodiment illustrated in FIGS. 5 and 7 is of particular use when eNB 4 is not aware of the current resource status of relay nodes identified as target cell candidates.

In the event that eNB 4 does not have enough information to select a cell from among RNa, RNb and one or more cells directly served by eNB 4, eNB 4 can send towards source cell access node 18 one or more handover request acknowledgement messages (either a single message or multiple messages) for more than one selected cell (which plurality selected cells can be differentiated in the one or more handover acknowledgement messages by the included cell IDs of those cells), and then the source access node 18 selects one of those selected cells as the target cell. The one or more selected cells can be a subset of the target cell candidates received during STEP 604.

With the techniques described above, unnecessary and short-lasting handovers can be avoided in a relay enhanced LTE-advanced network. The multiple handover preparation procedure is further enhanced by avoiding sending out a handover request to each target cell candidate, but instead sending a handover request from the target eNB to only the access node serving the target cell candidate determined by the target eNB to be the best candidate cell. This determination by the target eNB is facilitated by including information (such as UE measurement reports) about alternative target cell candidates in the HO request message sent to the target eNB. The determination by the target eNB of the best target cell candidate is based on: (i) the radio conditions between the UE and the target cell candidates (which is sent from the source cell access node to the target eNB in the enhanced handover request), as well as (ii) characteristics of the target cell candidates (such as whether a target cell candidate is a relay node cell (and therefore has a relatively limited coverage area) or is a cell served directly by an eNB (and therefore has a relatively wide coverage area).

In one variation, the target eNB also performs the access link admission control operation on behalf of its RNs in addition to the backhaul admission control operation. In order to enable the DeNB with this functionality, the RNs belonging to the target DeNB communicate their access link usage (load) to the target DeNB. This information alone can provide a rough estimation as to whether the necessary/desired bearers can be admitted over the access link for a relay node, but a more accurate estimate can be achieved by taking into account the UE measurement reports included in the HO request message received at the target DeNB from source cell access node. For example, two UEs, each having exactly the same bearers (the same number of bearers with the same QoS requirements) might require different amounts of radio resources on the access link if the radio link quality between the RN and the two UEs are very different.

Including the UE measurement reports in the HO request sent from the source cell access node to the target DeNB can be beneficial even in a non-relay setting, and/or when there is only one handover target cell candidate. The admission control can be more accurate because the target DeNB can calculate more precisely what extent of radio resources are required to admit the bearers of the UE, instead of just relying on the information about the free radio resources available at that time.

The handover request filtering technique of the kind illustrated in FIGS. 4 and 6 can save overhead on the wireless Un interface (i.e. the interface between the target DeNB and its relay nodes) and can reduce delay times, because the target DeNB does not have to send HO Request messages to multiple RN cells and wait for HO request acknowledgement messages back for all of those RN cells. If the UE that is the subject of the handover is moving at high speed and the target cell candidates identified in the handover request message received from the source cell access node includes one or more cells that are directly served by the target DeNB (i.e. not via a relay node), the target DeNB can instead choose to select a cell that is directly served by the target DeNB 4 as the target cell for the handover, and not send any handover request messages to any of its relay nodes.

Handover request ACK filtering of the kind illustrated in FIGS. 5 and 7 can ensure that the most optimal handover target is selected; and is preferable to having to compromise on quality by selecting as the target cell the cell for which it first receives a handover request acknowledgement message. In the case of the Handover request ACK filtering technique of the kind illustrated in FIGS. 5 and 7, the target DeNB is responsible for sending any required Handover Cancellation commands towards the candidate RNs whose Handover request ACK is not chosen to be forwarded towards the source cell access node, so that the non-selected relay nodes can free up the resources they have reserved for the handover (STEP 712). This involves relatively few resources and relatively small delays because the cancellation commands are originating from an eNB to which the relay nodes belong.

As mentioned above, a network involving relay nodes is just one specific example of a network in which the kind of techniques described above can be useful. The same kind of techniques are also useful in non-relay settings. For example, the handover request message sent by source cell access node could also identify as additional target cell candidates cells that are not served at all (i.e. directly or via one or more relay nodes) by the eNB that serves the top target cell candidate. The target eNB that serves the top target cell candidate and receives the handover request message from the source cell access node can include in the above-described HO request filtering operation or above-described HO Request ACK filtering operation these other cells not served at all by the target eNB. Alternatively, target eNB can be configured to not send handover request messages to the access nodes serving these unrelated target cell candidates unless all the one or more target cell candidates served by the target eNB cannot accept the handover, e.g. due to insufficient free resources.

Performing the target cell selection at an eNB that serves the top target cell candidate and potentially also one or more alternative target cell candidates has the advantage that it avoids the need to send information (e.g. load conditions) about those target cell candidates to another node.

In a network involving relay nodes, information regarding the speed of the UE can be very useful, as the coverage of a RN cell is generally much smaller than a normal eNB cell (i.e. a cell served directly by a eNB). If a typical RN cell radius is taken to be between about 50 m and 80 m, it will take a UE moving at 50 km/h only a maximum of between 7 and 11 seconds, respectively, to cross the whole RN cell. The duration could be even shorter if the UE does not traverse the centre of the cell, but just tangentially moves through the border area of the cell. According to one embodiment of the invention, a decision is made at the target eNB based on the reported speed of the UE as to whether it might be more optimal to select as the target cell a cell target candidate served directly by the target eNB (i.e. not via a relay node) instead of a target cell candidate served by a relay node, even if other indicators (such as UE measurement reports etc.) point to the selection of a relay node as the target cell. The handover request message (or group of handover request messages) sent from the source cell access node can include an information element (IE) comprising a historical list of up to 16 cells that the UE has most recently been connected to. The cell ID, cell type (which basically indicates whether the size of the cell is “very small”, “small”, “medium” or “large”), and the duration of occupation by the UE, is provided for each cell in the list. Accordingly, after one handover in each direction, neighbouring cells can be aware of each other's size. According to one embodiment of the invention, this IE also provides information about the speed of the UE in the source cell, for use by the target eNB in selecting a target cell from the target cell candidates.

In the kind of request-filtering technique illustrated in FIGS. 4 and 6, the factors that the target eNB uses to select one of a plurality of target cell candidates served (directly or indirectly) by the target eNB can include the speed of the UE (as discussed above), and any other restriction on the use of any of those cells at that time. For example, the target eNB might choose not to select a RN cell that could provide a link with the best radio conditions and quality of service (QoS) and has free radio resources, if that RN cell has been scheduled for shut down for energy saving purposes in the near future.

If the source cell access node is unable to support the multiple handover preparation in a single HO request message (i.e. is unable to operate with HO request messages identifying more than one target cell candidate), one alternative option can be for the source cell access node to send two or more separate HO requests concerning the same UE. For example, the target eNB may first receive one handover request message for one of its RN cells and after a while (before the HO request ACK is received from the RN cell, in the case of a two step admission control) receive another request for a cell served directly by it or another of its RN cells. In this case the target eNB can try to admit the UE to a cell served directly by it (or send a HO request to the other RN if the second request identified another of its RN cells), and wait for the response of the first HO request that was sent by the target eNB to the RN cell identified in the handover request message received first from the source cell access node. The target DeNB can then compare the two HO request ACKs, and forward only the best one (e.g. the one admitting the most bearers) towards the source cell access node.

In the example mentioned earlier in which the handover request message received at the target eNB identifies as one or more additional target cell candidates one or more cells served by one or more other eNBs, the primary target eNB can: send multiple HO requests towards those other eNBs, wait for the HO request ACKs from those other eNBs cells, and select a HO request ACK message for forwarding towards the source cell access node. In this example, the primary target eNB is also responsible for sending any required HO cancellation commands towards the other eNBs for the non-selected cells. The operations of the other eNBs include: forwarding HO requests towards their subordinate RNs or further subordinate eNBs, waiting for the HO request ACKs from those other eNBs cells, and selecting a HO request ACK message for forwarding towards the primary target eNB; and afterwards, forwarding any required HO cancellation commands towards their subordinate RNs that serve non-selected target cell candidates or even to further subordinate other eNBs that serve non-selected target cell candidates.

The above-described operations may require data processing in the various entities. The data processing may be provided by means of one or more data processors. Similarly various entities described in the above embodiments may be implemented within a single or a plurality of data processing entities and/or data processors. Appropriately adapted computer program code product may be used for implementing the embodiments, when loaded to a computer. The program code product for providing the operation may be stored on and provided by means of a carrier medium such as a carrier disc, card or tape. A possibility is to download the program code product via a data network. Implementation may be provided with appropriate software in a server.

For example the embodiments of the invention may be implemented as a chipset, in other words a series of integrated circuits communicating among each other. The chipset may comprise microprocessors arranged to run code, application specific integrated circuits (ASICs), or programmable digital signal processors for performing the operations described above.

Embodiments of the invention may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre stored design modules. Once the design for a semiconductor circuit has been completed, the resultant design, in a standardized electronic format (e.g., Opus, GDSII, or the like) may be transmitted to a semiconductor fabrication facility or “fab” for fabrication. In addition to the modifications explicitly mentioned above, it will be evident to a person skilled in the art that various other modifications of the described embodiment may be made within the scope of the invention.

1. A method, comprising: receiving at a first node one or more handover request messages relating to a handover of a communication device in a source cell not served by said first node, wherein said one or more handover request messages identify a plurality of target cell candidates for said handover including at least one cell served by said first node and one or more cells other than cells served directly by said first node; selecting at said first node one or more of the one or more cells other than the cells served directly by said first node; and sending one or more handover request messages towards one or more access nodes serving the one or more selected cells.

2. A method according to claim 1, wherein the selecting takes into account information about speed of movement of the communication device.

3. (canceled)

4. (canceled)

5. A method according to claim 1, further comprising: sending handover request messages respectively addressed to one or more nodes directly serving one or more of said one or more cells other than cells served directly by said first node; receiving from said one or more nodes respective acknowledgment messages including information regarding the suitability of the respective target cell candidates as the target cell for the handover; and selecting at said first node one or more of said plurality of target cell candidates based at least partly on said information included in the messages received from said one or more nodes.

6. (canceled)

7. A method according to claim 1, wherein said one or more cells other than cells directly served by said first node include one or more cells served by the first node via one or more relay nodes.

8. A method according to claim 1, wherein the one or more handover request messages include information about the radio conditions between the communication device and the plurality of target cell candidates.

9. (canceled)

10. (canceled)

11. (canceled)

12. A method, comprising: sending from an access node serving a source cell one a plurality of handover request messages relating to a handover of a communication device in said source cell, wherein said plurality of handover request messages identify a plurality of target cell candidates for said handover; receiving at said access node serving said source cell an indication of the result of a selection at another node serving one or more of said target cell candidates of one or more of said plurality of target cell candidates.

13. A method according to claim 12, wherein said selected one or more of said plurality of target cell candidates consists of a single target cell candidate or a group of target cell candidates defining a subset of all the target cell candidates identified in the plurality of handover request messages sent from the access node serving the source cell.

14. A method according to claim 12, wherein said selected one or more of said plurality of target cell candidates consists of a single target cell candidate.

15. A method according to claim 12, comprising receiving at said access node serving said source cell an indication of the result of a selection at another node serving one or more of said target cell candidates of a group of target cell candidates defining a subset of all the target cell candidates identified in the plurality of handover request messages sent from the access node serving the source cell; and selecting at said access node serving the source cell one of said group of target cell candidates as the target cell for the handover.

16. (canceled)

17. A method according to claim 12, comprising sending from said access node serving said source cell a single handover request message identifying the plurality of target cell candidates for the handover.

18. An apparatus comprising: a processor and memory including computer program code, wherein the memory and computer program code are configured to, with the processor, cause the apparatus to: receive at a first node one or more handover request messages relating to a handover of a communication device in a source cell not served by said first node, wherein said one or more handover request messages identify a plurality of target cell candidates for said handover including at least one cell served by said first node and one or more cells other than cells served directly by said first node; select at said first node one or more of the one or more cells other than the cells served directly by said first node; and send one or more handover request messages towards one or more access nodes serving the one or more selected cells.

19. An apparatus according to claim 18 wherein the wherein the memory and computer program code are configured to, with the processor, cause the apparatus to: select the selected cells taking into account information about speed of movement of the communication device.

20. An apparatus according to claim 19, wherein the memory and computer program code are configured to, with the processor, cause the apparatus to: receive at said first node said information about speed of movement of the communication device as part of the one or more handover request messages.

21. (canceled)

22. An apparatus according to claim 18, wherein the memory and computer program code are configured to, with the processor, cause the apparatus to: send handover request messages respectively addressed to one or more nodes directly serving one or more of said one or more cells other than cells served directly by said first node; receive from said one or more nodes respective acknowledgment messages including information regarding the suitability of the respective target cell candidates as the target cell for the handover; and select at said first node one or more of said plurality of target cell candidates based at least partly on said information included in the messages received from said one or more nodes.

23. An apparatus according to claim 22, wherein the memory and computer program code are configured to, with the processor, cause the apparatus to: generate handover cancellation messages respectively addressed to each of the one or more nodes from which said acknowledgement messages were received, except for the one or more nodes directly serving the selected target cell candidates.

24. An apparatus according to claim 18, wherein said one or more cells other than cells directly served by said first node include one or more cells served by the first node via one or more relay nodes.

25. An apparatus according to claim 18, wherein the one or more handover request messages include information about the radio conditions between the communication device and the plurality of target cell candidates.

26. (canceled)

27. (canceled)

28. (canceled)

29. An apparatus comprising: a processor and memory including computer program code, wherein the memory and computer program code are configured to, with the processor, cause the apparatus to: send from an access node serving a source cell a plurality of handover request messages relating to a handover of a communication device in said source cell, wherein said plurality of handover request messages identify a plurality of target cell candidates for said handover; and receive at said access node serving said source cell an indication of the result of a selection at another node serving one or more of said target cell candidates of one or more of said plurality of target cell candidates.

30. An apparatus according to claim 29, wherein said selected one or more of said plurality of target cell candidates consists of a single target cell candidate or a group of target cell candidates defining a subset of all the target cell candidates identified in the plurality of handover request messages sent from the access node serving the source cell.

31. (canceled)

32. An apparatus according to claim 29, wherein the memory and computer program code are configured to, with the processor, cause the apparatus to: receive at said access node serving said source cell an indication of the result of a selection at another node serving one or more of said target cell candidates of a group of target cell candidates defining a subset of all the target cell candidates identified in the plurality of handover request messages sent from the access node serving the source cell; and select at said access node serving the source cell one of said group of target cell candidates as the target cell for the handover.

33. An apparatus according to claim 32, wherein the memory and computer program code are configured to, with the processor, cause the apparatus to: receive said indication of the result of said selection of said group of target cell candidates in a single handover request acknowledgement message.

34. An apparatus according to claim 29, wherein the memory and computer program code are configured to, with the processor, cause the apparatus to: send from said access node serving said source cell a single handover request message identifying the plurality of target cell candidates for the handover.

35.-40. (canceled)
